(19) United States
(12) Patent Application Publication
(10) Pub. No.: US 2021/0387876 A1
(43) Pub. Date: Dec. 16, 2021

(54) USE OF CHLORAMINES AND CATIONIC POLYMERS IN WATER TREATMENT

(71) Applicant: Buckman Laboratories International, Inc., Memphis, TN (US)

(72) Inventor: Fred CALL, Newry, ME (US)

(73) Assignee: Buckman Laboratories International, Inc., Memphis, TN (US)

(21) Appl. No.: 17/343,778

(22) Filed: Jun. 10, 2021

Related U.S. Application Data
(60) Provisional application No. 63/038,367, filed on Jun. 12, 2020.

(51) Int. Cl. C02F 1/56; C02F 1/68; C02F 1/52

(52) U.S. Cl. CPC C02F 1/56; C02F 2103/001; C02F 1/5236; C02F 1/68

(57) ABSTRACT

Methods to improve water treatment for industrial uses are described. One method involves admixing source water, such as from a river or other flowing source or body of water, with a at least one water-soluble cationic polymer and at least one chloramine and a coagulant and/or flocculant to provide a treated water. The at least one water-soluble cationic polymer and at least one chloramine are present in an effective amount to improve water treatment efficiency, such as in allowing use of reduced amounts of coagulant and/or flocculant, and/or reduced suspended solids, turbidity, and/or color clarification.

This application claims the benefit under 35 U.S.C. § 119(e) of prior U.S. Provisional Patent Application No. 63/038,367 filed Jun. 12, 2020, which is incorporated in its entirety by reference herein.

### BACKGROUND OF THE INVENTION

The present invention relates to processes for treating waters, and particularly relates to using a unique combination of chemicals in water treatments, and more particularly relates to using a chloramine and water-soluble cationic polymer along with coagulants/flocculants in water treatments.

The present invention is, in part, useful in the pulp and paper industry and processes utilized in pulp and/or paper processes.

Pulp and paper manufacturers use large volumes of water in the wet-end production process, with river or lake water or other non-treated water being principal sources. This “influent” water almost always requires treatment to remove suspended particles prior to use in production to decrease microbiological growth, prevent product contamination, and decrease corrosion and clogging of equipment. Water treatments can involve the use of inorganic metal-based materials, such as aluminum sulfate or other aluminum salts, ferric chloride, and low molecular weight cationic polymers.

In addition, solids contact clarification systems for removal of suspended solids from water have used particular chemical means to enhance the density of the particles to be removed, thereby increasing the efficiency of the equipment and minimizing the time and space required to achieve the desired water purity. Growth of microbial organisms, including archaea, bacteria, algae, protozoa, metazoan, and/or other aquatic organisms in the water is a recognized problem for the water users accepting this clarified water, and this usually requires additional chemical disinfection treatments to control or eliminate their growth. Among the effective means for microbial control are certain oxidizing halogens and other biocides. Some of these biocides. particularly the oxidizing biocides, may interfere with the chemical additives for enhanced suspended solids removal process in the clarifier. To overcome this issue, an approach using monochloramine (MCA) for biological control has been applied with good effect on most common influent water microorganisms. However, certain algae strains are resistant to the effects of normal dosages of the monochloramine.

There is a need for improved water treatment methods which can reduce or avoid the indicated previous problems, allow use of poorer water quality intake sources for industrial and municipal uses and other applications, and/or provide other advantages.

Further, there is a further need to develop treatments that can be highly effective for removal of algae accumulations, and/or may provide at least additive effects in the reduction of chemical dosages used and/or provide a reduction in costs for clarification while maintaining surfaces clear of algae accumulation, and/or provide relatively low dosages of the biocide and other chemical additives to achieve the water treatment.

### SUMMARY OF THE INVENTION

A feature of the present invention is to provide methods to improve water treatment on raw or lower quality influent water to be used in industrial or municipal applications, and the like.

A further feature of the present invention is to provide microbial control in water systems that can avoid the quantity or number of chemicals needed to achieve clarified water.

An additional feature of the present invention is to reduce the chemical demand to achieve clarification in water and/or enhance the control of microorganisms.

A further feature of the present invention is the ability to control or maintain surfaces (e.g., such as one or more surfaces of a pulp and/or paper making plant) substantially clear or clear of algae accumulation.

Also, a feature of the present invention is to provide a process that is capable of avoiding excess biocides, such as oxidizing biocides.

Additional features and advantages of the present invention will be set forth in part in the description which follows, and in part will be apparent from the description, or may be learned by practice of the present invention. The objectives and other advantages of the present invention will be realized and obtained by means of the elements and combinations particularly pointed out in the written description and appended claims.

To achieve these and other advantages and in accordance with the purposes of the present invention, as embodied and broadly described herein, the present invention relates to a method for treating water, comprising a) mixing source water, at least one water-soluble cationic polymer, and at least one of a coagulant and flocculant, to provide treated water, wherein the treated water contains suspended solids. The coagulant/flocculant can be added prior to, at the same time as, or after the adding of the water-soluble cationic polymer. The addition of the at least one water-soluble cationic polymer and at least one of a coagulant and flocculant can, as an option, be added prior to a zone where turbulence and/or mixing occurs. The method further includes the step of adding at least one chloramine to the source water. The addition of the chloramine can occur, as an option, after the addition of the cationic polymer and coagulant/flocculant. As an option, the addition of at least one additional chemical product to enhance suspended solids agglomeration and removal can occur prior to, at the same time as, or after the addition of the chloramine. The method further includes b) at least partially separating the solids from the treated water.

The present invention further relates to a method for treating water, comprising a) mixing source water and at least one water-soluble cationic polymer to provide a first treated water, wherein the first treated water contains suspended solids; b) mixing the first treated water with at least one coagulant to provide a coagulated treated water; c) mixing the coagulated treated water with at least one chloramine and at least one flocculant to provide a flocculated treated water; and d) at least partially separating the suspended solids from the flocculated treated water.

It is to be understood that both the foregoing general description and the following detailed description are exemplary and explanatory only and are only intended to provide a further explanation of the present invention, as claimed.

### DETAILED DESCRIPTION OF THE PRESENT INVENTION

The methods of the present invention include the use of at least one water-soluble cationic polymer and at least one chloramine as part of a water treatment. The at least one water-soluble cationic polymer and at least one chloramine can be used in conjunction with a coagulant(s) and/or flocculant(s) to improve efficiency of the water treatment.

The water to be treated can be raw or natural sources of water, or other untreated or non-fully treated sources of water, which have suspended solids, turbidity, and/or discoloration, or other treatment needs.

In the present invention, the at least one water-soluble cationic polymer and at least one chloramine can be used in conjunction with coagulants and/or flocculants to improve water treatment of raw water to be used as industrial or municipal influent or source water. The at least one water-soluble cationic polymer and at least one chloramine can modify the performance of the water treatment and/or water product quality as compared to the treatment without the at least one water-soluble cationic polymer and/or at least one chloramine. Use of the at least one water-soluble cationic polymer and at least one chloramine in water treatments can allow for a) improved coagulation of suspended solids, and/or b) reductions in dosages needed for co-additives, such as coagulants and/or flocculants, and/or c) improved water clarification, as compared to water treatments without at least one water-soluble cationic polymer and/or at least one chloramine. The use of the at least one water-soluble cationic polymer and at least one chloramine in water treatments can provide increased removal of suspended solids, and/or reduced discoloration, and/or reduced turbidity of source water to be used in industrial water or municipal water applications, or others.

In more detail, the present invention, in part, relates to a method for treating water. The method involves the unique use of at least one water-soluble cationic polymer and at least one chloramine in combination with at least one coagulant and/or flocculant. Preferably, the method involves both the use of a coagulant and a flocculant. More preferably, the method involves the addition of coagulant first and then the addition of a flocculant afterwards, at non-overlapping time periods. More preferably, the method involves the addition of a coagulant in conjunction with the addition of a water-soluble cationic polymer, and then afterwards at non-overlapping time periods, the addition of a chloramine, and then the addition of a flocculant.

The method can comprise, consist essentially of, or consist of, or include the steps of: a) mixing source water, at least one water-soluble cationic polymer, and at least one of a coagulant and flocculant, to provide treated water. The treated water contains or includes or comprises suspended solids. As an example, the method can comprise, consist essentially of, or consist of, or include the steps of: a) mixing source water, at least one water-soluble cationic polymer, and at least one coagulant, to provide treated water

The method further includes the step of adding at least one chloramine to the source water. The addition of the chloramine can occur, as an option, after the addition of the cationic polymer and coagulant/flocculant. When this occurs, the at least chloramine is added to the treated water. As an option, the addition of at least one additional chemical product (e.g., a flocculant and/or coagulant) to enhance suspended solids agglomeration and removal can occur prior to, at the same time as, or after the addition of the chloramine. The method further includes b) at least partially separating the solids from the treated water. As an example, the method can further include the addition of at least one chloramine (after the addition of the water-soluble cationic polymer and coagulant) and further include the addition of at least one flocculant.

In the method, the coagulant/flocculant can be added prior to, at the same time as, or after the adding of the water-soluble cationic polymer. For instance, the coagulant/flocculant can be added within 1 second, within 5 seconds, within 15 seconds, within 1 minute, within 5 minutes, or within 10 minutes (or other times) of the adding of the water-soluble cationic polymer. The coagulant/flocculant can be added as a mixture with the water-soluble cationic polymer. The coagulant/flocculant can be added separately (e.g., by way of separate feed lines) with the water-soluble cationic polymer. The coagulant/flocculant can be added as a single dose, as multiple doses, or on a continuously or semi-continuous feed to the source water. The water-soluble cationic polymer can be added as a single dose, as multiple doses, or on a continuously or semi-continuous feed to the source water.

The addition of the at least one water-soluble cationic polymer and at least one of a coagulant and flocculant can, as an option, be added prior to a zone where turbulence and/or mixing occurs. Put another way, the at least one water-soluble cationic polymer and at least one of a coagulant and flocculant are preferably added such that agitation or mixing occurs afterwards. The at least one water-soluble cationic polymer and at least one of a coagulant and flocculant are added, generally, prior to the source water reaching a solids contact clarifier. The addition of at least one water-soluble cationic polymer and at least one of a coagulant and flocculant generally occurs such that coagulation (or agglomeration) of the suspended solids occurs prior to reaching the solids contact clarifier.

The amount of the at least one water-soluble cationic polymer and at least one of a coagulant and flocculant can be such that coagulation (or agglomeration) of the suspended solids occurs. For instance, the at least one water-soluble cationic polymer and at least one of a coagulant and flocculant can be added such that the weight ratio of coagulant/flocculant to water-soluble cationic polymer is from about 5:1 to about 50:1 or from about 5:1 to about 40:1, or from about 15:1 to about 30:1 (e.g., 15:1 to 25:1, 15:1 to 20:1, 20:1 to 30:1, 25:1 to 30:1 or weight ratios within or above or below these amounts).

In one aspect of the present invention, there can be achieved a combined effect with the combination of the at least one water-soluble cationic polymer and at least one of a coagulant and flocculant, such that the combination in the source water provides greater coagulation of the suspended solids. This can occur by electrostatic charge neutralization. It has been discovered that when the at least one water-soluble cationic polymer and at least one of a coagulant and flocculant are used in combination, the effects can be synergistic such that the coagulation of the suspended solids is greater than the use of the at least one water-soluble cationic polymer alone or the use of the at least one of a coagulant/flocculant alone. These improved effects can be greater when the combination is at least one water-soluble cationic polymer with at least one coagulant. The actual effects achieved with the combination can be greater than any additive effects. The improvement in coagulation can be at least 5%, at least 10%, at least 20%, at least 30%, at least 40%, or at least 50%, as determined by comparing the amount of coagulated solids that are formed using a combination of at least one water-soluble cationic polymer and at least one coagulant/flocculant versus either one of these components alone or compared to when no water-soluble cationic polymer and no chloramine is used but the same flocculant and the same coagulant are used.

With respect to the addition of the at least one chloramine, this preferably occurs after the step of adding the at least one water-soluble cationic polymer and at least one of a coagulant/flocculant. As an option, the chloramine can be added at other times, such as before the addition of at least one water-soluble cationic polymer and/or the addition of at least one coagulant/flocculant.

When added after the addition of at least one water-soluble cationic polymer and at least one coagulant/flocculant, the chloramine can be added after coagulation of the suspended solids begins, or after coagulation of the suspended solids is completed or substantially completed, or partially completed. For instance, the addition of the chloramine can occur approximately 30 seconds, 1 minute, 5 minutes, 10 minutes, 15 minutes or more after the addition of the at least one water-soluble cationic polymer and at least one coagulant/flocculant.

The amount of chloramine added can be any amount, for instance, from about 0.1 ppm to about 10 ppm, from about 0.5 ppm to about 10 ppm, from about 0.5 ppm to 5 ppm, from 0.5 ppm to 2.5 ppm, from 0.5 ppm to 2 ppm, from 1 ppm to 10 ppm, from 1.5 ppm to 10 ppm, or other amounts within any one of these ranges or above or below any one of these ranges, The ppm amount is based upon the source water being treated with the chloramine. The ppm amount can be based on chlorine ion concentration in the source water.

As indicated, the method can include the further step of adding at least one additional chemical agent, such as a flocculant and/or coagulant. This flocculant and/or coagulant can be the same or different from the flocculant and/or coagulant used in combination with the water-soluble cationic polymer. As one option, at this stage, the additional chemical agent is or includes a flocculant. As one option, at this stage, the additional chemical agent is or includes a flocculant and wherein at least one coagulant is used in combination with the water-soluble cationic polymer.

The addition of at least one additional chemical agent, such as at least one flocculant and/or at least one coagulant, can occur prior to, at the same time as, or after the adding of the chloramine(s). For instance, the coagulant/flocculant can be added within 1 second, within 5 seconds, within 15 seconds, within 1 minute, within 5 minutes, or within 10 minutes (or other times) of the adding of the chloramine(s). The coagulant/flocculant can be added as a mixture with the chloramine(s). The coagulant/flocculant can be added separately (e.g., by way of separate feed lines) with the chloramine(s). The coagulant/flocculant can be added as a single dose, as multiple doses, or on a continuously or semi-continuous feed to the source water. The chloramine(s) can be added as a single dose, as multiple doses, or on a continuously or semi-continuous feed to the source water.

As an option, the following sequence of additions can occur in this order: coagulant followed by water-soluble cationic polymer followed by chloramine followed by flocculant.

As an option, the following sequence of additions can occur in this order: water-soluble cationic polymer followed by coagulant followed by chloramine followed by flocculant.

As an option, the following sequence of additions can occur in this order: coagulant and water-soluble cationic polymer followed by chloramine followed by flocculant.

As an option, the following sequence of additions can occur in this order: coagulant and water-soluble cationic polymer followed by flocculant followed by chloramine.

As an option, the following sequence of additions can occur in this order: coagulant followed by water-soluble cationic polymer followed by chloramine and flocculant.

As an option, the following sequence of additions can occur in this order: coagulant and water-soluble cationic polymer followed by chloramine and flocculant.

As an option, the following sequence of additions can occur in this order: water-soluble cationic polymer followed by coagulant followed by chloramine and flocculant.

Examples of chloramines, water-soluble cationic polymers, coagulants, and flocculants are provided below.

The chloramines are, consist of, consist essentially of, comprise or include i) monochloramine (MCA) alone or ii) dichloramine (DCA) and/or trichloramine (TCA) with the monochloramine. The MCA can be present (as the chloramine source) in an amount of from 80% by weight to 100% by weight, or from 80% by weight to 98% by weight based on the total weight of chloramines present. The amount of monochloramine as part of the total amount of chloramines can be from about 90 wt % to 100 wt %, such as from about 85 wt % to 98 wt %, from about 90 wt % to 98 wt %, from about 95 wt % to 99.9 wt % based on total weight of chloramines present.

The dichloramine can be present in an amount of from 0 wt % to 20 wt %, or from about 2% to about 20 wt %, such as from about 2 wt % to about 15 wt %, from about 2 wt % to about 10 wt % or from 2 wt % to 5 wt % based on the total weight of the chloramines present. As an option, no dichloramine is present.

The trichloramine can be present in an amount of from 0 wt % to 20 wt %, or from about 2% to about 20 wt %, such as from about 2 wt % to about 15 wt %, from about 2 wt % to about 10 wt % or from 2 wt % to 5 wt % based on the total weight of the chloramines present. As an option, no trichloramine is present.

The dichloramine and trichloramine (in any combination) can be present in an amount of from about 0.1 wt % to about 20 wt %, such as from about 2 wt % to about 15 wt %, from about 2 wt % to about 10 wt % or from 2 wt % to 5 wt % based on the total weight of the chloramines present. The dichloramine can be present in amount greater than trichloramine. For instance, the dichloramine can be present in amount that is from about 10 wt % greater to about 90 wt % greater than the amount of trichloramine present.

The dichloramine can be present in an amount of from about 1.5 wt % to about 19.99 wt % and the trichloramine can be present with the dichloramine in an amount of from about 0.01 wt % to about 10 wt % based on total weight of the chloramines present. For example, the dichloramine can be present in an amount of from about 1.75 wt % to about 19.9 wt % and the trichloramine can be present with the dichloramine in an amount of from about 0.1 wt % to about 7 wt % based on total weight of the chloramines present. As an example, the dichloramine can be present in an amount of from about 1.9 wt % to about 19.9 wt % and the trichloramine can be present with the dichloramine in an amount of from about 0.1 wt % to about 5 wt % based on total weight of the chloramines present. As an example, the dichloramine can be present in an amount of from about 1.95 wt % to about 19.9 wt % and the trichloramine can be present with the dichloramine in an amount of from about 0.1 wt % to about 1 wt % based on total weight of the chloramines present.

A commercial example of a chloramine source that can be used is OXAMINE from Buckman Laboratories, Int'l.

With respect to the water-soluble cationic polymer, examples include quaternary ammonium compounds or polymers. One or more quaternary ammonium compounds can be used. Alternatively, or additionally, other water-soluble cationic polymers can be used.

The quaternary ammonium compound may be a compound with a single quaternary ammonium group or a polyquaternary ammonium compound. Examples of suitable quaternary ammonium compounds include for example, benzalkonium choride, (oxydiethyleneglycol)bis(coco alkyl)dimethyl ammonium chloride, which is commercially available in a formulation under the Trademark BUSAN 1014 from Buckman Laboratories International, Inc., N,N-dichlorobenzenesulfonamide (dichloramine B), N,N-diethyl-N-dodecyl-N-benzylammonium chloride, N,N-dimethyl-N-octadecyl-N-(dimethylbenzyl)ammonium chloride, N,N-dimethyl-N,N-didecylammonium chloride, N,N-dimethyl-N,N-didodecylammonium chloride, N,N,N-trimethyl-N-tetradecylammonium chloride, N-benzyl-N,N-dimethyl-N-(C₁₂-C₁₈ alkyl) ammonium chloride, N-(dichlorobenzyl)-N,-N-dimethyl -N-dodecylammonium chloride, N-hexadecylpyridinium chloride, N-hexadecylpyridinium bromide, N-hexadecyl-N,N,N-trimethylammonium bromide, N-dodecylpyridinium chloride, N-dodecylpyridinium bisulphate, N-benzyl-N-dodecyl-N,N-bis(beta-hydroxy-ethyl)ammonium chloride, N-dodecyl-N-benzyl-N,N-dimethylammonium chloride, N-benzyl-N,N-diethyl-N-(C₁₂-C₁₈ alkyl) ammonium chloride, ethyl-n-hexadecyl dimethylammonium bromide, N-dodecyl-N,N-dimethyl-N-ethylammonium ethyl sulfate, N-dodecyl-N,N-dimethyl-N-(1-naphthylmethyl) ammonium chloride, N-hexadecyl-N,N-dimethyl-N-benzylammonium chloride or N-dodecyl-N,N-dimethyl-N-benzylammonium chloride. The quaternary ammonium compound can be a polyquaternary ammonium compound. Polyquaternary ammonium compounds which may be used include those described in U.S. Pat. Nos. 3,874,870, 3,931,319, 4,027,020, 4,089,977, 4,111,679, 4,506,081, 4,581,058, 4,778,813, 4,970,211, 5,051,124, 5,093,078, 5,142,002 and 5,128,100 which are incorporated herein by reference thereto. Examples of a polyquaternary ammonium compound are poly(oxyethylene-(dimethyliminio)ethylene (dimethyliminio)ethylenedichloride), which is commercially available under the Trademark WSCP from Buckman Laboratories International, Inc., and bis (2-chloroethyl) ether-N,N,N′,N′-tetramethylethylenediamine copolymer), which is commercially available under the Trademark BUSAN 77 from Buckman Laboratories International, Inc.

Further examples of the quaternary ammonium compound include, but are not limited to, the following classes and examples of commercially available products: Monoalkyltrimethyl ammonium salts (Examples of commercially available products include cetyltrimethylammonium bromide or chloride as CTAB, tetradecyltrimethylammonium bromide or chloride (TTA), alkyltrimethyl ammonium chloride, alkylaryltrimethyl ammonium chloride, dodecyltrimethylammonium bromide or chloride, dodecyldimethyl-2-phenoxyethylammonium bromide, hexadecylamine: chloride or bromide salt, dodecyl amine or chloride salt, and cetyldimethylethyl ammonium bromide or chloride.), Monoalkyldimethylbenzyl ammonium salts (Examples include alkyldimethylbenzyl ammonium chlorides and benzethonium chloride as BTC), Dialkyldimethyl ammonium salts (Commercial products include domiphen bromide as DB, didecyldimethyl ammonium halides, and octyldodecyldimethyl ammonium chloride or bromide.), Heteroaromatic ammonium salts (Commercial products include cetylpyridium halides (CPC or bromide salt and hexadecylpyridinium bromide or chloride), cis-isomer 1-[3-chloroallyl]-3,5,7-triaza-1-azoniaadamantane, alkyl-isoquinolinium bromide, and alkyldimethylnaphthylmethyl ammonium chloride (BTC 1110), Polysubstituted quaternary ammonium salts, (Commercially available products include, but are not limited to alkyldimethylbenzyl ammonium saccharinate and alkyldimethylethylbenzyl ammonium cyclohexylsulfamate), Bis-quaternary ammonium salts (Product examples include 1,10-bis(2-methyl-4-aminoquinolinium chloride)-decane, 1,6-Bis {1-methyl-3-(2,2,6-trimethyl cyclohexyl)-propyldimethyl ammonium chloride]hexane or triclobisonium chloride, and the bis-quat referred to as CDQ by Buckman Brochures), and polymeric quaternary ammonium salts (includes polyionenes such as poly[oxyethylene(dimethyliminio)ethylene(di-methyliminio)ethylene dichloride], poly [N-3-dimethylammonio)propyl]N-[3-ethylneoxyethylenedimethylammonio)propyl]urea dichloride, and alpha-4-[1-tri s(2-hydroxyethyle)ammonium chloride).

Other examples of the quaternary ammonium compound that can be used are dimethyl ditallow ammonium chloride, dimethyl benzyl ammonium chloride, or any combination thereof.

As a further example, the water-soluble cationic polymer can be one or more polyionene polymers. An example, besides other examples described herein, can be poly[2-hydroxyethylene(dimethyliminio)-2-hydroxypropylene(dimethyliminio)methylene dichloride] or derivatives thereof. A commercial example of this polymer that can be used is APCA from Buckman Laboratories, Int'l.

The coagulant can be a tannin-based ammonium salt, ferric sulfate, ferric chloride, aluminum sulfate (alum), polyaluminum chloride (PAC), sodium aluminate, polyferric sulfate, aluminum chlorohydrate, polyaluminum silicate chloride, epichlorohydrin dimethylamine copolymer (epi-DMA), diallyldimethylammonium chloride (DADMAC), polyamines, melamine formaldehyde resin, polyethylenimine, or any combination thereof. The coagulant can be obtained from a commercial source, such as BUBOND® 408, BUBOND® 505, and BUBOND® 5828, from Buckman International Laboratories, Memphis Tenn., USA. The coagulant can be added to water in an amount of from about 10 ppm to about 3500 ppm or more, or from about 25 ppm to about 750 ppm, or from about 50 ppm to about 500 ppm, or from about 75 ppm to about 300 ppm, or from about 100 ppm to about 200 ppm, or other amounts, on a solids weight basis. These amounts can be used in either of the steps that have the option of adding at least one coagulant.

As an option, more than one coagulant can be used, such as two or more, or three or more.

The flocculant can be a polyacrylamide polymer, polyethyleneimine, polyamide-amine, polyamine, polyethylene oxide, sulfonated compound, starch derivative, polysaccharide, alginate, activated silica, colloidal clay, alum, ferric hydroxide, and the like, or any combination thereof. The flocculant can be obtained from a commercial source, such as BUFLOC® 5904, and BUFLOC® 5532, from Buckman International Laboratories. The polyacrylamide can be a high molecular weight ionically charged polyacrylamide. The flocculant can carry active groups with a charge which can counterbalance charge of the particles. Waters which contain a high proportion of colloidal organic substances may not be suitable for direct flocculation, and can be coagulated to destabilize the water before flocculation treatment. The flocculant can be added to water in an amount of from about 10 ppm to about 3500 ppm or more, or from about 25 ppm to about 1000 ppm, or from about 50 ppm to about 750 ppm, or from about 100 ppm to about 500 ppm, or from about 200 ppm to about 300 ppm, or other amounts, on a solids weight basis. These amounts can be used in either of the steps that have the option of adding at least one coagulant.

As an option, more than one flocculant can be used, such as two or more, or three or more.

In the present invention, the addition of the water-soluble cationic polymer, the least one chloramine, the at least one coagulant and/or flocculant all occur prior to the source water reaching the clarifier or clarifier zone or clarifier process steps.

In the present invention, as an option, no other biocide is used except for the at least one chloramine.

As indicated, the at least one water-soluble cationic polymer and at least one chloramine can be used in conjunction with at least one coagulant and/or flocculant, or other additives. Use of the at least one water-soluble cationic polymer and at least one chloramine in such methods can allow for decreased coagulant and/or flocculant dosage requirements as compared to water treatment without the water-soluble cationic polymer and chloramine to achieve a specific treatment efficiency level, such as with respect to removal of suspended solids, color, and/or turbidity. For instance, the at least one water-soluble cationic polymer and at least one chloramine can be used as an additive to be used with coagulants or flocculants for water treatment, wherein the coagulants' efficiency can be improved (e.g., lower coagulant dosage, lower turbidity, lower color value).

Treatment of a raw or natural water source, such as water drawn from flowing water or bodies of water, with a treatment method of the present invention can give a better quality water product. The water to be treated can be river water, stream water, lake water, pond water, reservoir water, well water, spring water, runoff water, cistern water, desalinated seawater, and the like, or any combinations thereof. This better quality can be obtained in terms of improved clarity, reduced color, and/or more efficient removal of suspended solids from raw water, and/or other improvements, or any combinations of these improvements. These improvements can allow use of poorer water sources as intake or influent water to be treated before use in industrial and municipal uses and other applications. The treatment can be expanded to reuse of waste water, within a facility or of waste water by other subsequent users.

The water product of treatment methods of the present invention may be used directly, such as for industrial process water, or in municipal water uses not requiring chlorination, or other uses. The water product of treatment methods of the present invention may be further treated, such as by chlorination or other water treatment methods, such as to provide a drinking water or other grades or types of treated water.

As indicated, the water treated with at least one water-soluble cationic polymer and at least one chloramine(s) with coagulant(s) and/or flocculant(s) can then be processed through one or more clarifiers. The clarifier can be a conventional clarifier or clarifying system typically used in water treatment plants. The clarifier can be or include rectangular or circular sedimentation tanks with central inlet baffles and with solids scraper and skimmer arms under a rotating bridge or can have an effluent weir structure above the fluid surface. Any settling tanks built with mechanical means for continuous removal of solids being deposited by sedimentation, for instance, can be used.

As indicated, the combined use of at least one water-soluble cationic polymer and at least one chloramine(s) with coagulant(s) and/or flocculant(s) can enhance clarification (e.g., reduce suspended solids, color, and/or turbidity) of the water. As an example, the step of promoting the formation of flocs is performed by adding one or more coagulants and/or flocculants to the water. If both are used, preferably the coagulant and flocculant are added sequentially. If a coagulant and flocculant is used at a coagulation/flocculation reactor, the coagulant can be preferably added first in a first stage of processing, followed by addition of flocculant in a second stage of processing. Suitable coagulants and/or flocculants for treatment of water are indicated infra and can include those generally known in the art, and may be selected based, for example, on the particular water source materials being processed. As an option, the at least one water-soluble cationic polymer and at least one chloramine can be added before treatment of the water with coagulant and/or flocculant or can be added after treatment of the water with coagulant and/or flocculant. The at least one water-soluble cationic polymer and at least one chloramine can impart enhanced treatment efficacy when added before, or during, or after coagulation/flocculation.

Using the water treatment methods of the present invention, turbidity can be decreased at least 10%, or at least 15%, or at least 25%, in the treated water after the separating as compared to treated water without the at least one water-soluble cationic polymer and at least one chloramine. Color can be decreased at least 5%, or at least 10%, or at least 25%, in the treated water after the separating as compared to treated water without the at least one water-soluble cationic polymer and at least one chloramine. A dosage of coagulant used on the water which is treated with the at least one water-soluble cationic polymer and at least one chloramine can be reduced by at least 40%, or at least 60%, or at least 80%, compared to a dosage used on water that is unmodified with the at least one water-soluble cationic polymer and at least one chloramine and treated with the coagulant and flocculant, and provide at least the same weight percentage of solids removal from the water. Similar reductions can be provided in the dosage of flocculant.

As indicated, the at least one water-soluble cationic polymer and at least one chloramine improves (reduces) the amount of suspended solids, turbidity, and/or color of water or other water properties as compared to the water without the at least one water-soluble cationic polymer and at least one chloramine.

In treating water, any of the components of the present invention added to the source water (e.g, the at least one water-soluble cationic polymer and at least one chloramine, flocculant, coagulant) can be added by itself as a dry particulate, or as dispersed in a fluid carrier, such as a suspension, slurry, gel, or pulp, or other forms. The carrier can be aqueous (water), an organic solvent, or mixtures of different organics solvents and/or water. An organic solvent may be an alcohol, such as isopropanol, ethanol, glycol, polyethylene glycol, acetone, and the like, or any combinations thereof. The at least one water-soluble cationic polymer and at least one chloramine can be dispersed in dilute or concentrated forms. The amounts of at least one water-soluble cationic polymer and at least one chloramine in a carrier liquid may be from about 0.1 wt % to about 99 wt %, or from about 5 wt % to about 90 wt %, or from about 25 wt % to about 75 wt %, or other amounts, based on the solids content of the at least one water-soluble cationic polymer and at least one chloramine and the total weight of the fluid and all additives. The temperature of any fluid used to disperse the at least one water-soluble cationic polymer and at least one chloramine preferably is kept between the freezing and boiling points of the fluid, and may be room or ambient temperature or other temperatures.

Although the effective amount of at least one water-soluble cationic polymer and at least one chloramine may vary, depending on the water composition and conditions, the at least one water-soluble cationic polymer can be added in an amount of from about 1 ppm to about 1,000 ppm or more, or from 1 ppm to 100 ppm, or from about 2 ppm to about 40 ppm, or from about 3 ppm to about 50 ppm, or from about 5 ppm to about 100 ppm, or other amounts, all on a solids weight basis.

The at least one water-soluble cationic polymer and at least one chloramine may be used alone or in combination with other additives. As indicated, the combined use of at least one water-soluble cationic polymer and at least one chloramine with coagulant and/or flocculant can enhance water treatment performance and results. Their combined use can comprise their sequential additions or simultaneous addition. The at least one water-soluble cationic polymer and at least one chloramine may be introduced into raw water at a single point or in multiple points, in a continuous or non-continuous manner. It may, for example, be introduced into a flowing water stream, or batch or semi-batch water held in a tank or vessel, using a metering pump (e.g., if in fluid-dispersed form), or it may be gravity fed (e.g., if in dry particulate form). When referring herein to at least one water-soluble cationic polymer and at least one chloramine addition, the addition can entail addition of the at least one water-soluble cationic polymer and at least one chloramine separately into the process apparatus, or in combination with another feedstream fed to the same apparatus, or both. The addition of the at least one water-soluble cationic polymer and/or the addition of at least one chloramine to water for treatment and/or the flocculant and/or the coagulant can be accompanied by stirring or agitation to disperse the at least one water-soluble cationic polymer and/or at least one chloramine and/or the flocculant and/or the coagulant throughout the water in a substantially uniform or uniform manner.

For water held in a vessel or tank, an agitator mechanism such as a mixer with an impeller mechanism or other mixing mechanism may be used, which can be conventional types.

For addition of the at least one water-soluble cationic polymer and/or at least one chloramine and/or coagulant and/or flocculant to a flowing stream, an in-line mixer may be used, or may not be needed if the fluid stream is in sufficiently turbulent flow conditions to cause mixing of the added component(s) and the flowing water.

As referenced herein, coagulation can involve the destabilization of colloids by neutralizing the forces that keep them apart. For instance, cationic coagulants provide positive electric charges to reduce the negative charge (zeta potential) of the colloids. As a result, the particles can collide to form larger particles (flocs). Rapid mixing typically is required to disperse the coagulant throughout the liquid. Care must be taken not to overdose the coagulants as this can cause a complete charge reversal and restabilize the colloid complex. The flocs may not be visible to the naked eye (e.g., microflocs). Flocculation can be the action of polymers to form bridges between the flocs, and bind the particles into large agglomerates or clumps. Flocculation can increase the particle size of the floc to form visible suspended particles. Bridging can occur when segments of the polymer chain adsorb on different particles and help particles aggregate. For instance, an anionic flocculant can react against a positively charged suspension, adsorbing on the particles and causing destabilization either by bridging or charge neutralization. In flocculation, the flocculating agent should be added by slow and gentle mixing to allow for contact between the small flocs and to agglomerate them into larger particles. The newly formed agglomerated particles are quite fragile and can be broken apart by shear forces during mixing. Care must also be taken to not overdose the polymer as doing so can cause settling/clarification problems. For instance, anionic polymers themselves are lighter than water. As a result, increasing their dosage can increase the tendency of the floc to float and not settle. Once suspended particles are flocculated into larger particles, they can usually be removed from the liquid by sedimentation, provided that a sufficient density difference exists between the suspended matter and the liquid. Such particles can also be removed or separated by media filtration, straining or floatation. When a filtering process is used, the addition of a flocculant may not be required since the particles formed by the coagulation reaction may be of sufficient size to allow removal. The flocculation reaction not only can increase the size of the floc particles to settle them faster, but also can affect the physical nature of the floc, making these particles less gelatinous and thereby easier to dewater.

With the present invention, the following can be achieved: control/removal of algae accumulations, and/or the reduction of chemical dosages used and/or the reduction in costs for clarification while maintaining surfaces clear of algae accumulation, and/or use of low dosages of the biocide and other chemical additives to achieve the water treatment.

As an option in at least one embodiment, the methods of the present invention provide no algae control or reduction to the treated water.

As an option in at least one embodiment, the methods of the present invention provide no microorganism control or reduction to the treated water.

The present invention further includes the following aspects/embodiments/features in any order and/or in any combination:
1. A method for treating water, comprising a) adding at least one water-soluble cationic polymer to a source water, b) adding at least one of a coagulant and flocculant to the source water to provide treated water, wherein the treated water contains suspended solids, c) adding at least one chloramine to the source water, and d) at least partially separating the solids from the treated water.
   2. The method of any preceding or following embodiment/feature/aspect, wherein steps a) through c) occur in any order, and step d) occurs after steps a) through c).
   3. The method of any preceding or following embodiment/feature/aspect, wherein step a) and b) occur in any order and step c) occurs after steps a) and b).
   4. The method of any preceding or following embodiment/feature/aspect, wherein step a) occurs prior to, at the same time, or after step b).
   5. The method of any preceding or following embodiment/feature/aspect, said method comprising a) adding at least one water-soluble cationic polymer to a source water, b) adding at least one coagulant to the source water to provide treated water, wherein the treated water contains suspended solids, c) adding at least one chloramine to the source water, and d) adding at least one flocculant to the source water, and e) at least partially separating the solids from the treated water, wherein step a) occurs prior to, at the same time, or after step b), and wherein, step c) occurs prior to steps a) and b), and wherein step d) occurs prior to, at the same time, or after step c), and wherein step d) occurs after steps a) and b).
   6. The method of any preceding or following embodiment/feature/aspect, wherein the addition of said water-soluble cationic polymer and said coagulant is followed by agitation or mixing of said source water.
   7. The method of any preceding or following embodiment/feature/aspect, wherein the addition of said water-soluble cationic polymer and said coagulant is followed by agitation or mixing of said source water, and then said addition of said at least one chloramine occurs.
   8. The method of any preceding or following embodiment/feature/aspect, wherein the at least one chloramine is added to the source water in an amount such that the source water has from about 0.1 ppm to 20 ppm chloramine.
   9. The method of any preceding or following embodiment/feature/aspect, wherein turbidity is decreased at least 10% in the treated water after the separating as compared to treated water without said chloramine or said water-soluble cationic polymer.
   10. The method of any preceding or following embodiment/feature/aspect, wherein color is decreased at least 5% in the treated water after the separating as compared to treated water without said chloramine or said water-soluble cationic polymer.
   11. The method of any preceding or following embodiment/feature/aspect, wherein the source water is river water, stream water, lake water, pond water, reservoir water, well water, spring water, runoff water, cistern water, desalinated seawater, or any combinations thereof.
   12. Another embodiment/feature/aspect is a method for treating water, comprising:

a) mixing source water and water-soluble cationic polymer to provide a first treated water, wherein the first treated water contains suspended solids;

b) mixing the first treated water with at least one coagulant to provide a coagulated treated water;

c) mixing the coagulated treated water with at least one chloramine to provide a chloramine treated water;

d) mixing the chloramine treated water with at least one flocculant to provide a flocculated treated water; and

e) at least partially separating the solids from the flocculated treated water.

13. Another embodiment/feature/aspect is a method for treating water, comprising:

a) mixing source water with water-soluble cationic polymer and at least one coagulant, in any order, to provide a first treated water, wherein the first treated water contains suspended solids;

b) mixing the first treated water with at least one chloramine and at least one flocculant, in any order, to provide a chloramine flocculated treated water; and

c) at least partially separating the solids from the chloramine flocculated treated water.

14. The method of any preceding or following embodiment/feature/aspect, wherein a dosage of the coagulant used on the water which is treated with the water-soluble cationic polymer and the chloramine is reduced by at least 40% compared to a dosage used on water that is unmodified with the water-soluble cationic polymer and the chloramine and treated with the coagulant and flocculant, and provide at least the same weight percentage of solids removal from the water.
15. The method of any preceding or following embodiment/feature/aspect, wherein the source water is river water, stream water, lake water, pond water, reservoir water, well water, spring water, runoff water, cistern water, desalinated seawater, or any combinations thereof.
16. The method of any preceding or following embodiment/feature/aspect, wherein the addition of the coagulant, the addition of the water-soluble cationic polymer, the addition of the chloramine, and the addition of the flocculant are performed sequentially in non-overlapping time periods.
17. The method of any preceding or following embodiment/feature/aspect, wherein the addition of the coagulant and the water-soluble cationic polymer, the addition of the chloramine and the flocculant are performed sequentially in non-overlapping time periods.
18. The method of any preceding or following embodiment/feature/aspect, wherein the addition of the water-soluble cationic polymer, the addition of the coagulant, the addition of the chloramine, and the addition of the flocculant are performed sequentially in non-overlapping time periods.
19. The method of any preceding or following embodiment/feature/aspect, wherein the addition of the water-soluble cationic polymer, the addition of the coagulant, the addition of the chloramine and the flocculant are performed sequentially in non-overlapping time periods.
20. The method of any preceding or following embodiment/feature/aspect, wherein the coagulant is a tannin-based ammonium salt, ferric sulfate, ferric chloride, aluminum sulfate (alum), polyaluminum chloride (PAC), sodium aluminate, polyferric sulfate, aluminum chlorohydrate, polyaluminum silicate chloride, epichlorohydrin dimethylamine copolymer (epi-DMA), dialIyldimethylammonium chloride (DADMAC), polyamines, melamine formaldehyde resin, polyethylenimine, or any combination thereof.
21. The method of any preceding or following embodiment/feature/aspect, wherein the flocculant is a polyacrylamide polymer, polyethyleneimine, polyamide-amine, polyamine, polyethylene oxide, sulfonated compound, starch derivative, polysaccharide, alginate, activated silica, colloidal clay, alum, ferric hydroxide, or any combination thereof.
22. The method of any preceding or following embodiment/feature/aspect, wherein an amount of the coagulant added and an amount of the water-soluble cationic polymer is at a weight ratio of from 5:1 to 40:1.
23. The method of any preceding or following embodiment/feature/aspect, wherein an amount of the coagulant added and an amount of the water-soluble cationic polymer is at a weight ratio of from 15:1 to 30:1.
24. The method of any preceding or following embodiment/feature/aspect, wherein the water-soluble cationic polymer is at least one polyionene.
25. The method of any preceding or following embodiment/feature/aspect, wherein the water-soluble cationic polymer is at least one quaternary ammonium compound or polymer.

The present invention can include any combination of these various aspects, features, or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method for treating water, comprising a) adding at least one water-soluble cationic polymer to a source water, b) adding at least one of a coagulant and flocculant to the source water to provide treated water, wherein the treated water contains suspended solids, c) adding at least one chloramine to the source water, and d) at least partially separating the solids from the treated water.

2. The method of claim 1, wherein steps a) through c) occur in any order, and step d) occurs after steps a) through c).

3. The method of claim 2, wherein step a) and b) occur in any order and step c) occurs after steps a) and b).

4. The method of claim 2, wherein step a) occurs prior to, at the same time, or after step b).

5. The method of claim 1, said method comprising a) adding the at least one water-soluble cationic polymer to the source water, b) adding the at least one coagulant to the source water to provide the treated water, wherein the treated water contains suspended solids, c) adding the at least one chloramine to the source water, and d) adding the at least one flocculant to the source water, and e) said at least partially separating the solids from the treated water, wherein step a) occurs prior to, at the same time, or after step b), and wherein, step c) occurs prior to steps a) and b), and wherein step d) occurs prior to, at the same time, or after step c), and wherein step d) occurs after steps a) and b).

6. The method of claim 1, wherein the addition of said water-soluble cationic polymer and said coagulant is followed by agitation or mixing of said source water.

7. The method of claim 1, wherein the addition of said water-soluble cationic polymer and said coagulant is followed by agitation or mixing of said source water, and then said addition of said at least one chloramine occurs.

8. The method of claim 1, wherein the at least one chloramine is added to the source water in an amount such that the source water has from about 0.1 ppm to 20 ppm chloramine.

9. The method of claim 1, wherein turbidity is decreased at least 10% in the treated water after the separating as compared to treated water without said chloramine or said water-soluble cationic polymer.

10. The method of claim 1, wherein color is decreased at least 5% in the treated water after the separating as compared to treated water without said chloramine or said water-soluble cationic polymer.

11. The method of claim 1, wherein the source water is river water, stream water, lake water, pond water, reservoir water, well water, spring water, runoff water, cistern water, desalinated seawater, or any combinations thereof.

12. A method for treating water, comprising:
a) mixing a source water and a water-soluble cationic polymer to provide a first treated water, wherein the first treated water contains suspended solids;
b) mixing the first treated water with at least one coagulant to provide a coagulated treated water;
c) mixing the coagulated treated water with at least one chloramine to provide a chloramine treated water;
d) mixing the chloramine treated water with at least one flocculant to provide a flocculated treated water; and
e) at least partially separating the solids from the flocculated treated water.

13. A method for treating water, comprising:
a) mixing a source water with a water-soluble cationic polymer and at least one coagulant, in any order, to provide a first treated water, wherein the first treated water contains suspended solids;
b) mixing the first treated water with at least one chloramine and at least one flocculant, in any order, to provide a chloramine flocculated treated water; and
c) at least partially separating the solids from the chloramine flocculated treated water.

14. The method of claim 13, wherein a dosage of the coagulant used on the source water which is treated with the water-soluble cationic polymer and the chloramine is reduced by at least 40% compared to a dosage used on water that is unmodified with the water-soluble cationic polymer and the chloramine and treated with the coagulant and flocculant, and provide at least the same weight percentage of solids removal from the water.

15. The method of claim 13, wherein the source water is river water, stream water, lake water, pond water, reservoir water, well water, spring water, runoff water, cistern water, desalinated seawater, or any combinations thereof.

16. The method of claim 13, wherein the addition of the coagulant, the addition of the water-soluble cationic polymer, the addition of the chloramine, and the addition of the flocculant are performed sequentially in non-overlapping time periods.

17. The method of claim 13, wherein the addition of the coagulant and the water-soluble cationic polymer, the addition of the chloramine and the flocculant are performed sequentially in non-overlapping time periods.

18. The method of claim 13, wherein the addition of the water-soluble cationic polymer, the addition of the coagulant, the addition of the chloramine, and the addition of the flocculant are performed sequentially in non-overlapping time periods.

19. The method of claim 13, wherein the addition of the water-soluble cationic polymer, the addition of the coagulant, the addition of the chloramine and the flocculant are performed sequentially in non-overlapping time periods.

20. The method of claim 1, wherein the coagulant is added and is a tannin-based ammonium salt, ferric sulfate, ferric chloride, aluminum sulfate (alum), polyaluminum chloride (PAC), sodium aluminate, polyferric sulfate, aluminum chlorohydrate, polyaluminum silicate chloride, epichlorohydrin dimethylamine copolymer (epi-DMA), diallyldimethylammonium chloride (DADMAC), polyamines, melamine formaldehyde resin, polyethylenimine, or any combination thereof.

21. The method of claim 1, wherein the flocculant is added and is a polyacrylamide polymer, polyethyleneimine, polyamide-amine, polyamine, polyethylene oxide, sulfonated compound, starch derivative, polysaccharide, alginate, activated silica, colloidal clay, alum, ferric hydroxide, or any combination thereof.

22. The method of claim 1, wherein an amount of the coagulant added and an amount of the water-soluble cationic polymer is at a weight ratio of from 5:1 to 40:1.

23. The method of claim 1, wherein an amount of the coagulant added and an amount of the water-soluble cationic polymer is at a weight ratio of from 15:1 to 30:1.

24. The method of claim 1, wherein the water-soluble cationic polymer is at least one polyionene.

25. The method of claim 1, wherein the water-soluble cationic polymer is at least one quaternary ammonium compound or polymer.
